(19) United States
(12) Patent Application Publication
(10) Pub. No.: US 2007/0087926 A1
(43) Pub. Date: Apr. 19, 2007

(54) Arrangement in a press roll and a press roll

(75) Inventor: Erkki Aho, Elimaki (FI)

Correspondence Address: BIRCH STEWART KOLASCH & BIRCH, PO BOX 747, FALLS CHURCH, VA, 22040-0747, US

(73) Assignee: VAAHTO OY, Hollola (FI)

(21) Appl. No.: 11/543,963

(22) Filed: Oct. 6, 2006

(30) Foreign Application Priority Data
Oct. 7, 2005 (FI) 20051006

(51) Int. Cl. F16C 13/00

(52) U.S. Cl. 492/47

(57) ABSTRACT

An arrangement in connection with supporting a press roll which press roll comprises a support shaft (2) extending through a rotating roll shell (1) in the axial direction and being supported using at least one bearing element (14) in at least one bearing point (3, 4) to a support frame (5), such as a bearing block, and which arrangement comprises a torque support for preventing the rotation of the support shaft (2). At least one torque support (11) has been arranged to at least one of the bearing points (3, 4) inside a bearing housing (5) or equivalent.

### BACKGROUND OF THE INVENTION

The invention relates to an arrangement in a press roll according to the preamble of claim 1.

The invention also relates to a press roll according to claim 20.

Previously is known an arrangement of a deflection-compensated roll in which, between a non-rotatable centre shaft and an outer surface of the bearing housing or an outer bearing cap of the roll, there is a support element i.e. wedge support by means of which the non-rotatability of the centre shaft is provided in relation to the bearing housings. The wedge simultaneously functions as a torque support between the centre shaft and the bearing housing. The support element conveys force from the shaft to the bearing housing and further to an external support of the bearing housing. Such a solution is presented e.g. in specification FI74785B in FIG. 1, part 66.

The structure is commonly used in paper and board machines in press and calender applications.

In known arrangements, the positioning of the torque support causes a moment of rotation to the bearing housing in relation to the centre of the housing around the vertical axis y.

The object of this invention is to achieve a totally novel solution by means of which the disadvantages of known prior art are avoided. Another object of the invention is especially to provide a support solution for the bearing housing of the press roll of the shoe press. The object of the invention is to provide a structure which can be applied also in other targets.

### BRIEF DESCRIPTION OF THE INVENTION

The invention is based on an idea according to which a torque support is arranged to a bearing line inside the bearing housing.

More precisely, the apparatus according to the invention is mainly characterised by at least one torque support having been arranged to at least one of the bearing points inside the bearing housing or equivalent.

The apparatus according to the invention is further characterised by what is stated in claims 2-19.

The solution according to the invention has numerous significant advantages.

The structure is characterised by the torque support being inside the bearing in an exactly right place i.e. within the range of forces. Then, the torque support can be arranged in an ideal way within the range of forces. By arranging the torque support through the bearing element between the support shaft and a support frame i.e. bearing housing, an advantageous and appropriate way in respect of its manufacturing technique is provided for the positioning of the torque support and the conveying of forces. By forming openings, most suitably formed holes, to the wall of the bearing housing and to the bearing element and further by positioning them according to the invention, an extremely good arrangement can be provided for supporting the press roll which also enables deflections and stretchings characteristic to the roll in use. By shaping the end of the torque support and the counter elements of the support shaft, support characteristics of the torsional moment and clearances of the support shaft can be enabled. On the other hand, by positioning the torque support to the bearing line and also horizontally to the centre line of the roll, an optimal solution is provided for the support. By shaping the torque support cylindrical at least partly so that it is able to rotate around its own axis, a support solution enabling the deflection of the support shaft is provided.

A further advantage of positioning the torque support is that the rotating torque supports in relation to the bearing housing cause no problems for the inclining of the roll in connection with the roll change or fabric change or in a similar maintenance situation. Seen from the machine direction MD, the roll can thus be positioned in an inclined position in the cross-direction CD so that one bearing housing is in position and the other is removed and the tending-side end of the roll is lifted up to a maximum angle of around 1 degree in a normal situation. This corresponds in the y direction the maximum distance of around 100 mm. necessarily, there is no need for placing intermediate pieces under the bearing housing of the shoe roll, but the bearing housings of the roll can be positioned directly on a basic frame. There is a small difference in the height of the bearing housings between the tending and driving side of the rolls, because due to the outrunning of the roll the structure requires a small release piece between the roll and the basic frame in order to be able to lower the bearing housing of the driving side to an outrunning carriage.

### BRIEF DESCRIPTION OF THE FIGURES

Next, the invention will be described in detail by means of an example with reference to the accompanying drawing, in which

FIG. 1 shows an apparatus according to the invention,

FIG. 1a schematically shows a detail of an apparatus according to the invention,

FIG. 2 shows a detail of an apparatus according to the invention,

FIG. 2a shows a cross-section along line A-A of FIG. 2,

FIG. 3 shows an exploded view of a portion of an apparatus according to the invention,

FIG. 3a shows a perspective view of a portion of an arrangement according to the invention,

FIG. 3b shows a side view of a portion of an arrangement according to the invention,

FIG. 3c shows a perspective view of another portion of an arrangement according to the invention,

FIG. 3d shows a side view of a portion of an arrangement according to the invention,

FIG. 4 shows a bearing portion of an arrangement according to the invention,

FIG. 4a shows a cross-section along line B-B enlarged of FIG. 4,

FIG. 5 shows a detail of end areas of a support shaft of a press roll according to the invention,

FIG. 5a shows a detail Det 1 of FIG. 5,

FIG. 5b shows a detail Det 2 of FIG. 5, and

FIG. 6 shows a partial section of an arrangement according to the invention seen from the axial direction of the roll.

### DETAILED DESCRIPTION OF THE INVENTION

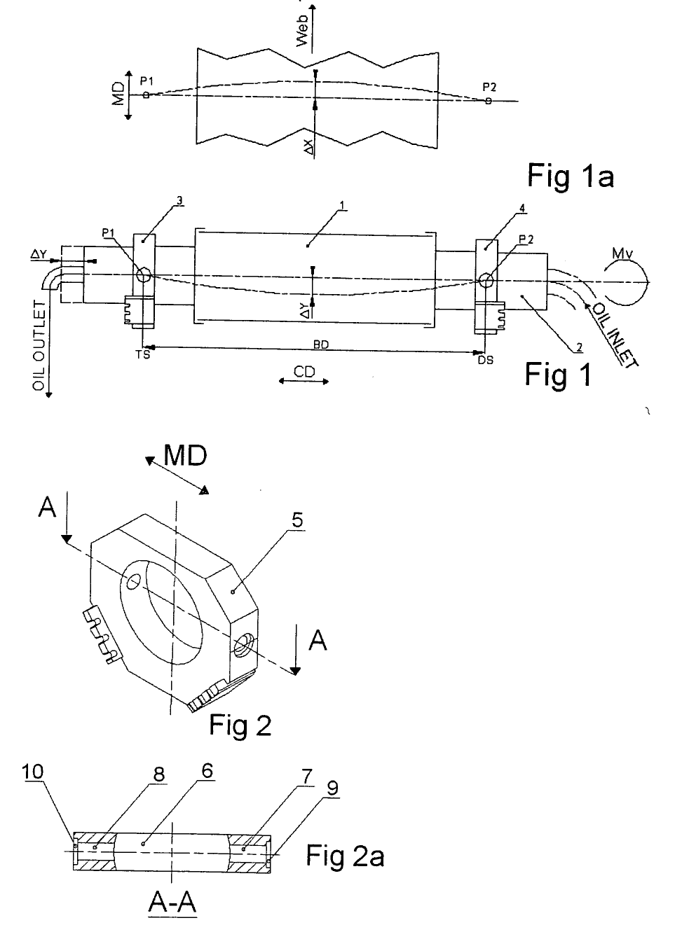

FIG. 1 shows a general situation of a roll according to the invention. Part 1 is a rotating surface fabric i.e. belt shell of a press roll, typically a shoe roll. Part 2 is a support shaft of the roll. The support shaft is generally a support beam in the bearing points of which there are shaft journals or similar. Parts 3 and 4 are bearings of the roll on the tending and driving side. The bearings 3 and 4 remain in position in the operating situation of the roll, and the centre shaft of the roll can expand because of e.g. thermal extension for a travel Δz towards the tending side TS of the machine. Usually, the bearing 4 on the driving side DS of the roll is a so-called fixed bearing, and the bearing of the tending side TS is free. Designation DS means the driving side of the roll. The roll deflects via a centre point P1, P2 of the bearings 3 and 4. The deflection reaches its maximum value Δy on the centre shaft of the roll from the effect of force prevailing in a press gap i.e. nip between the roll shell and a counter element (not shown in the figure). Simultaneously, the roll can deflect a little from the effect of the nip to the run direction of the web for a deflection Δx (FIG. 1a) which is perpendicular in relation to the deflection of the nip. The bearing distance of the roll is designated with measure BD. Also torsional moment Mv exerts to the support shaft 2, caused by, inter alia, forces prevailing in the press gap. A purpose of the arrangement according to the invention is, inter alia, to shift the forces of the torsional moment in question from the support shaft 2 to the support frame.

During the operation of the roll, medium, such as oil, can be led inside the roll. The medium is led from one end of the roll and, correspondingly, removed from the other or the same end of the roll, depending on the type of the roll. In the solution according to the figure, medium is supplied from the driving side DS and led away from the tending side TS.

FIG. 2 shows a bearing housing 5 in the bearing point of the bearing 3 and 4 and its cross-section A-A (FIG. 2a). The bearing housing is typically but not necessarily similar on both sides of the machine. Inside the bearing housing 5, there is a hole in the axial direction i.e. in the cross-direction CD of the machine on the side surface of which is formed a typically spherical machining 6. Through the side surfaces of the wall of the bearing housing 5 are formed advantageously cylindrical holes 7, 8 and for a locking element 12 counterbore machinings 9, 10. In the figure, the holes 7, 8 formed for a torque support 11 are typically substantially machine-directional MD. Furthermore, on the front surface of the bearing housing, there is an installation machining for a bearing element 14 coming inside the housing 5, not shown in the figure.

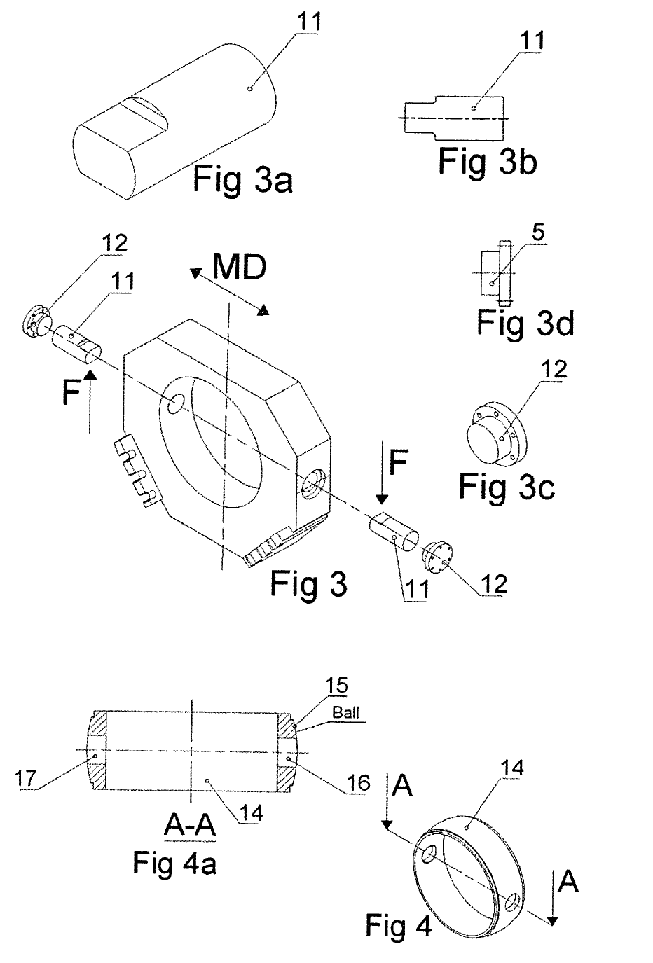

FIGS. 3, 3a, 3b, 3c, 3d show in more detail the shape of the torque support 11 and special machinings 13 for the reception of forces F. The forces caused by the torsional moment are led by means of the torque support 11 from the support shaft via the torque support to a fixed support frame 5, especially a bearing housing. The holes 7, 8 in the section corresponding the bearing housing 5 of the torque support 11 have mainly cylindrical shape, when the portion extending to the roll shaft has form-machinings which are in the embodiment of the figure substantially in the axial direction of the roll. The shape of the locking element 12 is shown in a separate figure. The torque support sets inside the bearing housing to a space 7 and 8 (FIG. 2). The locking element 12, on the other hand, sets after the torque support inside the bearing housing to a space 9 and 10. The locking element 12 keeps the torque support 11 in position inside the bearing housing in the machine direction MD.

FIGS. 4 and 4a show a detailed shape of the bearing element 14 inside the bearing housing, typically a ball bearing. Section B-B (FIG. 4a) shows a sectional view of the bearing. The bearing element is an annular element through which the support shaft 2 of the roll has been arranged. A radial outer surface 15 of the bearing element is at least partially formed spherical. Cylindrical holes 16, 17 in the centre line of the bearing are arranged for the torque support 11, whereby it extends through the bearing element in the radial direction always inside the support shaft 2.

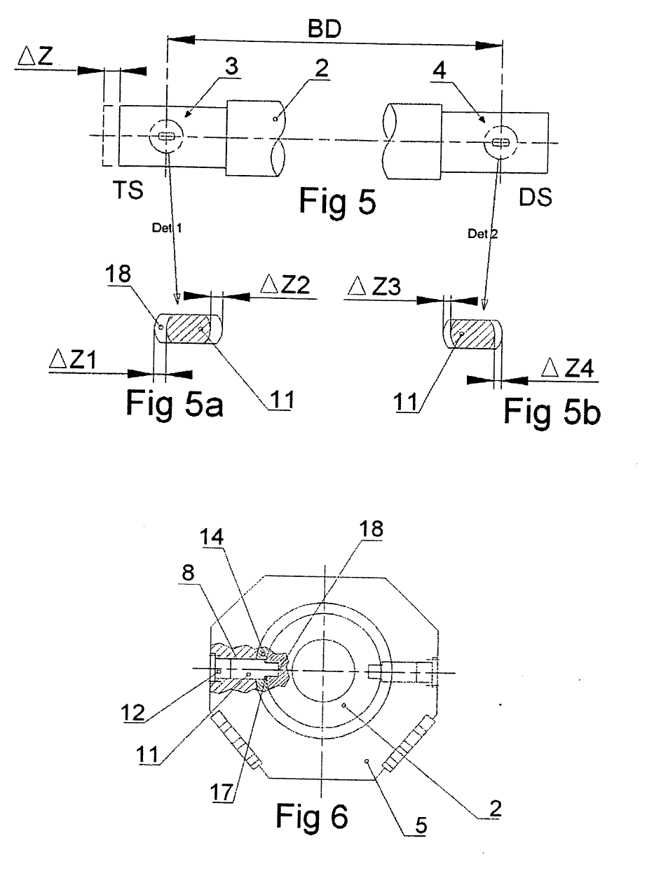

FIGS. 5, 5a and 5b show the ends of the support beam 2 in the bearing points 3 and 4. At the ends of the support shaft 2 are machined counterbore machinings 18, 19 for the torque support 11 in the bearing points 3, 4 of the roll. It is advantageous to have the counterbore machinings 18, 19 on both sides of the shaft, whereby force balance becomes the best possible, i.e. two pieces per bearing. If the surface fabric 1 is non-central in relation to the support shaft 2, one of the torque supports in the bearing points can be omitted completely, because the moment of rotation Mv of the nip load in relation to the shaft of the support beam is almost totally omitted. For manufacturing technical reasons, a small clearance Δz1 is required between the torque support 11 and the support beam 2 and, because of thermal expansion, a clearance Δz2 on the tending side TS of the machine. Correspondingly, for the driving side DS of the machine, corresponding clearances Δz3 are required on both sides of the torque support 11. The clearance Δz3 is very small compared to the clearances of the tending side TS.

FIG. 6 shows a partial section of an arrangement according to the invention seen from the axial direction of the roll. To the bearing housing 5 is arranged a bore 8. Also to the bearing ring 14 is arranged a corresponding bore 17 through. To the support shaft 2 is formed a counter element, typically a counterbore 18, for the end of the torque support 11. The bore 8 of the bearing housing, the bore 17 of the bearing ring 14 and the counterbore 18 of the support shaft are arranged in incidence so that the torque support 11 can be set in position. After this, a stopping element i.e. locking element 12 can be set into the bore 8 formed in the bearing housing. The locking element 12 can be further fastened with fastening elements, such as screws, to the bearing housing 5.

The invention thus relates to an arrangement in connection with supporting a press roll which press roll comprises a support shaft 2 extending through a rotating roll shell 1 in the axial direction and being is supported using at least one bearing element 14 in at least one bearing point 3, 4 to the support frame 5, such as a bearing block, and which arrangement comprises a torque support for preventing the rotation of the support shaft 2. At least one torque support 11 has been arranged to at least one of the bearing points 3, 4 inside the bearing housing 5 or equivalent. According to an advantageous embodiment, the torque support 11 is arranged through the bearing element 14 between the support frame 5 and the support shaft 2. At least one opening 16, 17, most suitably a formed hole, has been arranged to the bearing element 14. In the figure, two openings 16, 17 are formed to the bearing ring 14, advantageously diametrally in relation to each other. Through the wall of the bearing housing 5 is arranged at least one opening 7, 8, most suitably a formed hole, advantageously horizontally i.e. in the machine direction MD, in the centre line of the bearing housing.

To the support shaft 2 is arranged at least one counterbore 18, 19 or equivalent for the end of the torque support 11. The counterbore of the support shaft 2 is advantageously in the bearing line of the roll horizontally in the centre line of the roll. Typically, there are two counterbores and they are located on the opposite sides of the shaft diametrally. The counterbores 18, 19 are form-machinings for the end of the torque support 11. In the embodiment according to FIGS. 3, 3a, 3b, the end fitting to the counterbores of the support shaft 2 of the torque support comprises parallel surfaces 13 which are provided e.g. by machining a portion of a cylindrical bar away.

The opening 7, 8 arranged through the wall of the bearing housing 5, the opening 7, 8 of the bearing element 14 and the counterbore 18, 19 of the support shaft 2 are arranged in incidence so that the torque support 11 can be set in position.

The bearing element 14 comprises a spherical surface 15 which has at least one permeate formed hole 16, 17 horizontally in the centre line of the bearing. The support shaft 2 internally torque-supported in the bearing point 3, 4 is one- or multi-part. The support shaft 2 internally torque-supported in the bearing point 3, 4 can be central or non-central in relation to the surface fabric 1.

In the first end of the roll, the form-machining 18, 19 has such a shape that it locks the bearing housing 5 and the roll 2 mainly in relation to each other and allows only a CD-directional deflection Δy of the roll and only in a slight amount a deflection Δx occurring in the run direction MD of the web.

At the opposite end in relation to the first end of the roll, the form-machining 18, 19 has such a shape which allows the thermal expansion of the roll during operation and also length variation related to the precision of manufacture of the roll.

The torque support 11 is totally inside the bearing housing 5. There is at least one or more torque supports arranged on the periphery of the ball bearing. The torque support 11 allows a deflection of the roll in the CD direction of the machine. The torque support 11 also allows the roll to deflect a little in the run direction (MD direction) of the machine. The torque support 11 is form-machined to fit to the form-machining 18, 19 of the support shaft 2 and the form-machining 7, 8 of the bearing housing 5.

On the side surfaces of the bearing housing 5, there are form-machining counterbores 9, 10 for the locking elements 12 of the torque support. There are one or more locking elements 12, according to the number of the torque supports 11. The locking elements 12 lock the torque supports 11 inside the bearing housing 5.

The invention also relates to a press roll which press roll comprises characteristics of the arrangement described above. The arrangement according to the invention can also be used, inter alia, in connection with the press roll of the shoe press i.e. shoe roll.

It is obvious to those skilled in the art that the invention is not limited to the embodiments described above, but it can be varied within the scope of the enclosed claims. When necessary, the characteristic features possibly described in this specification together with other characteristic features can also be used separate from each other.

1. An arrangement in connection with supporting a press roll which press roll comprises a support shaft (2) extending through a rotating roll shell (1) in the axial direction and being supported using at least one bearing element (14) in at least one bearing point (3, 4) to a support frame (5), such as a bearing block, and which arrangement comprises a torque support for preventing the rotation of the support shaft (2), characterised in that at least one torque support (11) is arranged to at least one of the bearing points (3, 4) inside a bearing housing (5) or equivalent.

2. An arrangement according to claim 1, characterised in that the torque support (11) is arranged through the bearing element (14) between the support frame (5) and the support shaft (2).

3. An arrangement according to claim 1, characterised in that at least one opening (16, 17), most suitably a formed hole, is arranged to the bearing element (14).

4. An arrangement according to claim 1, characterised in that through the wall of the bearing housing (5) is arranged at least one opening (7, 8), most suitably a formed hole, which is advantageously horizontally i.e. in the machine direction MD, in the centre line of the bearing housing.

5. An arrangement according to claim 1, characterised in that at least one counterbore (18, 19) or equivalent is arranged to the support shaft (2) for the end of the torque support (11).

6. An arrangement according to claim 1, characterised in that the counterbore (18, 19) of the support shaft (2) is advantageously in the bearing line of the roll, horizontally in the centre line of the roll.

7. An arrangement according to claim 1, characterised in that the opening (7, 8) arranged through the wall of the bearing housing, the opening (7, 8) of the bearing element and the counterbore (18, 19) of the support shaft are arranged in incidence so that the torque support can be set in position.

8. An arrangement according to claim 1, characterised in that the bearing element (14) comprises a spherical surface (15) which has at least one permeate formed hole (16, 17) horizontally in the centre line of the bearing.

9. An arrangement according to claim 1, characterised in that the support shaft (2) internally torque-supported in the bearing point (3, 4) can be one-or multi-part.

10. An arrangement according to claim 1, characterised in that the support shaft (2) internally torque-supported in the bearing point (3, 4) can be central or non-central in relation to the surface fabric (1).

11. An arrangement according to claim 1, characterised in that, in the first end of the roll, the form-machining (18, 19) has such a shape that it locks the bearing housing (5) and the roll (2) mainly in relation to each other and allows only a CD-directional deflection (Δy) of the roll and only in a slight amount a deflection (Δx) occurring in the run direction MD of the web.

12. An arrangement according to claim 1, characterised in that, at the opposite end in relation to the first end of the roll, the form-machining (18, 19) has such a shape which allows the thermal expansion of the roll during operation and also length variation related to the precision of manufacture of the roll.

13. An arrangement according to claim 1, characterised in that the torque support (11) is totally inside the bearing housing, at least one or more around the ball bearing.

14. An arrangement according to claim 1, characterised in that the torque support (11) allows a deflection of the roll in the CD direction of the machine.

15. An arrangement according to claim 1, characterised in that the torque support (11) allows the roll to deflect also a little in the run direction (MD direction) of the web.

16. An arrangement according to claim 1, characterised in that the torque support (11) is form-machined to fit to the form-machining (18, 19) of the support shaft (2) and the form-machining (7, 8) of the bearing housing (5).

17. An arrangement according to claim 1, characterised in that, on the side surfaces of the bearing housing (5), there are form-machining counterbores (9, 10) for the locking elements (12) of the torque support.

18. An arrangement according to claim 1, characterised in that there are one or more locking elements (12), according to the number of the torque supports.

19. An arrangement according to claim 1, characterised in that the locking elements (12) lock the torque supports (11) inside the bearing housing (5).

20. A press roll, characterised in that it comprises an arrangement according to claim 1.
